(19) United States
(12) Patent Application Publication
(10) Pub. No.: US 2007/0230900 A1
(43) Pub. Date: Oct. 4, 2007

(54) Content Copy Control Apparatus and Content Copy Control Method

(76) Inventor: Go Toriumi, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/587,773

(22) PCT Filed: Apr. 27, 2005
(86) PCT No.: PCT/JP05/08449

§ 371 Date: Apr. 4, 2007

(30) Foreign Application Priority Data
Apr. 28, 2004 (JP) 2004-133227

(51) Int. Cl. H04N 5/91

(52) U.S. Cl. 386/83

(57) ABSTRACT

High-quality digital content to which a copy control signal of “copy one generation” is added can be carried with a portable terminal. Original digital content in a recording device can be retained with the quality kept unchanged.

A picture record data control device 101a converts picture record data stored in a picture record data memory device 101c in format and writes the converted picture record data into a removable medium 102. Then, the picture record data control device 101a updates output status information 24 in a picture record information table 101b into “outputted” so as to prohibit any operation to the picture record data. Further, when a removable medium 102 is newly inserted into a removable medium device 101e, the picture record data control device 101a updates the output status information 24 in the picture record information table 101b that corresponds to picture record data deleted from the removable medium 102 so as to permit operation of the picture record data.

### TECHNICAL FIELD

The present invention relates to a content copy control apparatus and a content copy control method used when digital content stored in a recording device is copied only once to a playback terminal, such as a removable medium, and more particularly, to a content copy control apparatus and a content copy control method for avoiding quality degradation of content when the content is copied with a format conversion of the content.

### BACKGROUND ART

Generally, for protecting copyrights, a copy control signal for content has recently been added to digital content stored in a DVD or digital content in digital television broadcasting, and the like. For example, digital copy control information is added to digital content of digital television broadcasting and includes a copy control attribute, such as “copy prohibited” which prohibits any copying, “copy one generation” which allows copying only once, and “copy free” which does not restrict copying. Particularly, in the digital terrestrial/BS television broadcasting, a copy control signal of “copy one generation” has been added to digital content since April 2004 in Japan. Further, in the digital terrestrial/BS television broadcasting, a copy control is performed with use of a control card called a B-CAS card (see the Association for Promotion of Digital Broadcasting, the Internet URL: http://www.d-pa.org/copyctr/index.html [searched on April 8, 2004] or http://www.d-pa.org/copyctr/ [searched on Apr. 12, 2005] (Non-patent Document 1)). Further, for example, Japanese laid-open patent publication No. 2003-263370 (Patent Document 1) discloses a program that can reliably prohibit, from multiple copying, information that is allowed to be copied only once (paragraphs 0033-0064, FIGS. 3-4).

Further, there have recently been products that convert recorded broadcast programs of analog television broadcasting or content recorded in accordance with a Digital Video (DV) standard (content to be viewed with a usual television receiver) into a high compression ratio format so that the content can be viewed with a portable terminal. For example, content is converted into a high compression ratio format for smaller screens by using MPEG4 or Windows Media Technology (WMT). This enables to carry the content together with a playback terminal, such as a portable player, a PDA, a cellular phone, and the like. Further, the converted content can be viewed or watched by such a playback terminal.

### DISCLOSURE OF INVENTION

### Problems to be Solved by the Invention

Herein, it is assumed that a copy control signal of “copy one generation” is added to content of digital television broadcasting and such content data is recorded by using a recording device, such as a DVD recorder or hard disk recorder and is viewed by the use of a playback terminal, such as a portable player or a cellular phone. In this event, the following problems arise ever when the conditions of “copy one generation” are met or satisfied.

For example, when the recorded content in the recording device is converted into a format for the portable terminal, such as MPEG4, and is carried or conveyed together with the playback terminal, the recorded data is written into the playback terminal in its format. In this case, the original recorded data is deleted from the recording device. Accordingly, when the same data (content) is to be viewed again with a usual television receiver or the like, then playing back or reproducing should be made by the use of the data that is written into the playback terminal and that has a low picture quality due to the conversion into the format for portable terminals (a low resolution, a low frame rate, and the like).

In order to allow the data converted into a format for a portable terminal to be reusable with the original picture quality in a usual television receiver, an inverse transform of the format should be performed for a long period of time. Alternatively, the format for the portable terminal should be changed so as to be used in a usual television receiver.

Further, if data recorded in a DVD recorder or a hard disk recorder is configured so that the data can be viewed directly with a playback terminal without any format conversion, then the cost and size of the playback terminal are increased, and a battery of a long life is indispensable.

It is, therefore, an object of the present invention to provide a content copy control apparatus and a content copy control method which allow high-quality digital content with a copy control signal of “copy one generation” to be carried with a portable terminal, and which can retain original digital content in a recording device with the quality thereof kept.

### MEANS FOR SOLVING THE PROBLEMS

Specifically, a content copy control apparatus according to the present invention is for use in copying content to a portable removable medium and is characterized by comprising content memory means for storing content table memory means for recording a content information table in which the content stored by the content memory means is associated with output status information indicating whether the content has been outputted to a removable medium; and content operation prohibition means for prohibiting operation to content outputted to the removable medium, among the content stored by the content memory means, based on the content information table recorded by the table memory means. For example, the operation to content means a user's command input to output, play back, edit, or move the content. Further, for example, the prohibition of operation means that the specified operation can not be performed when it is determined that the content has been outputted to an external removable medium.

Further, the content copy control apparatus may comprise a recording device for storing the picture record data and a playback terminal for playing back the picture record data and may be used for copying picture record data as content to a portable removable medium. The recording device includes table memory means for recording a picture record information table in which the picture record data stored in the recording device is associated with output status information indicating whether the picture record data have been outputted to a removable medium; picture record data prohibition means for prohibiting operation to picture record data outputted to the removable medium, among the picture record data stored in the recording device, based on the picture record information table stored by the table memory means; format conversion means for converting the picture record data in format; and picture record data writing means for writing or deleting the picture record data converted in format by the format conversion means into the removable medium. The playback terminal includes picture record data reading means for reading or deleting the picture record data from the removable medium; playback/deletion command means for commanding playback or deletion of the picture record data stored in the removable medium; and playback means for playing back or outputting the picture record data stored in the removable medium in accordance with a command from the playback/deletion command means.

Further, the content copy control apparatus may comprise deletion time set means for setting time at which picture record data written in to the removable medium are to be deleted. The playback/deletion command means may command deletion of picture record data from the removable medium after a predetermined period of time has elapsed since the picture record data were written into the removable medium, in accordance with the set time set by the deletion time set means. The picture record data prohibition means may update the output status information in the picture record information table that corresponds to the deleted picture record data into information indicating that the picture record data have not been outputted, at the same time when the playback/deletion command means deletes the picture record data, in accordance with the set time set by the deletion time set means. With such an arrangement, deletion of picture record data from the removable medium after the output of the picture record data can be automated, so that an input operation of a user can be simplified.

Further, the playback terminal may include deletion notification sending means for sending deletion notification information indicating that the picture record data have been deleted from the removable medium to the recording device. The picture record data prohibition means may update the output status information in the picture record information table that corresponds to the deleted picture record data into information indicating that the picture record data has not been outputted, based on the deletion notification information received from the playback terminal. With such an arrangement, it is possible to notify a deletion operation of picture record data written into the removable medium and a playback request of original picture record data with use of the communication means, so that an input operation of a user can be simplified.

Further, the recording device may include picture record data output means for outputting the picture record data converted in format by the format conversion means to the playback terminal. The playback terminal may include picture record data input means for inputting the picture record data outputted from the picture record data output means, and picture record data memory means for storing the picture record data inputted by the picture record data input means. The table memory means may record a picture record information table in which the picture record data stored in the recording device is associated with output status information indicating whether the picture record data has been outputted to the playback terminal. The picture record data prohibition means may prohibit operation to picture record data outputted to the playback terminal, among the picture record data stored in the recording device, based on the picture record information table. The playback/deletion command means may command playback or deletion of the picture record data stored in the picture record data memory means. The playback means may play back or output the picture record data stored in the picture record data memory means in accordance with a command from the playback/deletion command means.

A content copy control method according to the present invention is used for copying content to a removable medium and is characterized by comprising a step of storing content; and a step of prohibiting operation to content outputted to a portable removable medium, among the stored content, based on a content information table in which the stored content is associated with output status information indicating whether the content has been outputted to the removable medium.

Further, the content copy control method may comprise a step in which a recording device for storing picture record data as content prohibits operation to picture record data outputted to a portable removable medium, among the picture record data stored in the recording device, based on a picture record information table in which the stored picture record data is associated with output status information indicating whether the picture record data has been outputted to the removable medium; a step in which the recording device converts the picture record data in format; a step in which the recording device writes or deletes the picture record data converted in format into the removable medium; a step in which a playback terminal for playing back picture record data reads or deletes the picture record data from the removable medium; a step in which the playback terminal commands playback or deletion of the picture record data stored in the removable medium; and a step in which the playback terminal plays back or outputs the picture record data stored in the removable medium.

Further, the content copy control method may comprise a step of setting time at which picture record data written into the removable medium is to be deleted; a step in which the playback terminal deletes the picture record data from the removable medium after a predetermined period of time has elapsed since the picture record data was written into removable medium, in accordance with the set time; and a step of updating the output status information in the picture record information table that corresponds to the deleted picture record data into information indicating that the picture record data has not been outputted, at the same time when the picture record data is deleted, in accordance with the set time. With such an arrangement, deletion of picture record data from the removable medium after the output of the picture record data can be automated, so that an input operation of a user can be simplified.

Further, the content copy control method may comprise a step in which the playback terminal sends deletion notification information indicating that the picture record data has been deleted from the removable medium to the recording device; and a step in which the recording device updates the output status information in the picture record information table that corresponds to the deleted picture record data into information indicating that the picture record data has not been outputted, based on the deletion notification information received from the playback terminal. With such an arrangement, it is possible to notify a deletion operation of picture record data written into the removable medium and a playback request of original picture record data with use of the communication means, so that an input operation of a user can be simplified.

Further, the content copy control method may comprise a step in which the recording device prohibits operation to picture record data outputted to the playback terminal, of the picture record data stored in the recording device, based on a picture record information table in which the picture record data stored in the recording device is associated with output status information indicating whether the picture record data has been outputted to the playback terminal; a step in which the recording device outputs the picture record data converted in format to the playback terminal; a step in which the playback terminal inputs the picture record data outputted from the recording device; a step in which the playback terminal stores the inputted picture record data; a step in which the playback terminal commands playback or deletion of the stored picture record data; and a step in which the playback terminal plays back or outputs the stored picture record data.

The content copy control apparatus according to the present invention may comprise a recording device for storing the picture record data and a playback terminal for playing back the picture record data. The recording device includes table memory means for recording a picture record information able in which the picture record data stored in the recording device is associated with output status information indicating whether the picture record data had been outputted, picture record data prohibition means for prohibiting operation to picture record data outputted to the playback terminal, among the picture record data stored in the recording device, based on the picture record information table stored by the table memory means. The playback terminal includes picture record data reading means for reading the picture record data from the recording device, playback/deletion command means for commanding playback or deletion of the picture record data stored in the playback terminal, and deleting means for deleting the picture record data from the playback terminal in response to a command representative of the deletion from the playback/deletion command means.

### EFFECTS OF THE INVENTION

The present invention enables to copy content into a portable removable medium. Among stored content, prohibition is made about operating content that is being outputted to an external removable medium or the like. Accordingly, digital content with a copy control signal of “copy one generation” can be carried along with a portable terminal. Original digital content in a recording device can be retained with a high quality kept unchanged.

### BRIEF DESCRIPTION OF DRAWINGS

FIG. 1 is a block diagram showing an example of an arrangement of a content copy control apparatus according to the present invention;

FIG. 2 is an explanatory diagram showing an example of a picture record information table 101b;

FIG. 3 is a flow chart showing an example of an output control process, which is performed by a picture record data control device 101a when picture record data is to be outputted to a removable medium 102;

FIG. 4 is a flow chart showing an example of a control process, which is performed by the picture record data control device 101a when a removable medium 102 is newly inserted into a removable medium device 101e;

FIG. 5 is a flow chart showing an example of a deletion control process, which is performed by the picture record data control device 101a when picture record data stored in the removable medium 102 are to be deleted;

FIG. 6 is a block diagram showing another example of the arrangement of the content copy control apparatus;

FIG. 7 is a block diagram showing still another example of the arrangement of the content copy control apparatus;

FIG. 8 is a block diagram showing still another example of the arrangement of the content copy control apparatus; and

FIG. 9 is an explanatory diagram showing an example of a picture record information table 401b.

### BEST MODE FOR CARRYING OUT THE INVENTION

### Embodiment 1

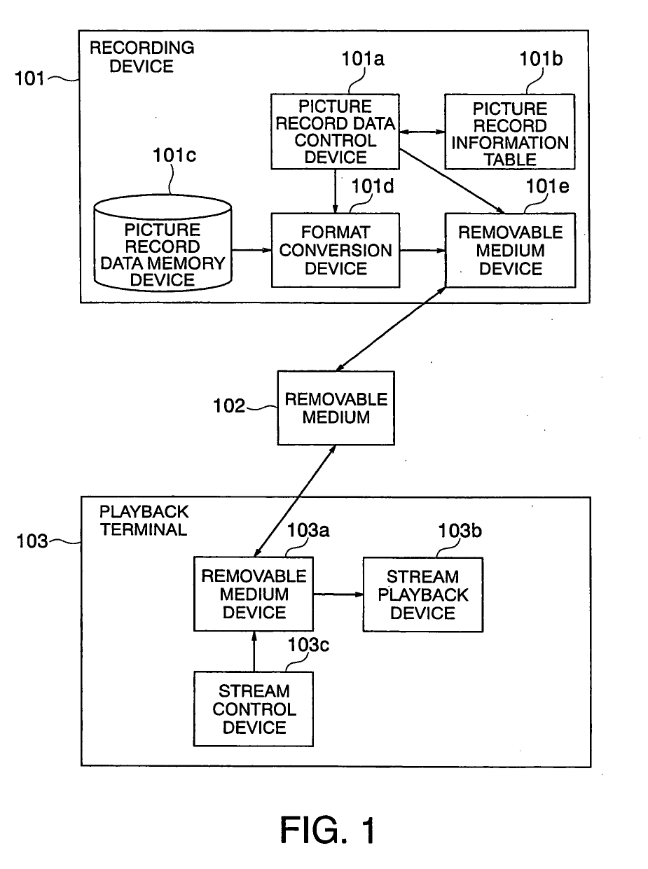

A first embodiment of the present invention will be described below with reference to the drawings. FIG. 1 is a block diagram showing an example of an arrangement of a content copy control apparatus according to the present invention. In the present embodiment, a user can carry picture record data (digital content) recorded in a removable medium to be converted into a format for a playback terminal. Further, in the present embodiment, original picture record data stored in a recording device can be retained with the quality thereof kept unchanged.

As shown in FIG. 1, the content copy control apparatus includes a recording device 101, such as a DVD recorder or a hard disk recorder, and a playback terminal 103, such as a portable player or a cellular phone. The recording device 101 includes a picture record data control device 101a, a picture record information table 101b, a picture record data memory device 101c, a format conversion device 101d, and a removable medium device 101e. Further, the playback terminal 103 includes a removable medium device 103a, a stream playback device 103b, and a stream control device 103c.

Specifically, the picture record data control device 101a is implemented by a CPU of the recording device 101, which operates according to a program. The picture record data control device 101a has a function of managing recorded data stored in the picture record data memory device 101c by the use of the picture record information table 101b.

The picture record data control device 101a has a function of commanding the format conversion device 101d to output picture record data stored in the picture record data memory device 101c to a removable medium 102 and recording the outputted picture record data in the picture record information table 101b. Further, the picture record data control device 10a also has a function of confirming picture record data stored in the removable medium 102 and reflecting information of picture record data deleted from the removable medium 102, upon the picture record information table 101b. Furthermore, the picture record data control device 101a may have a function of commanding the removable medium device 101e to delete data from the removable medium 102.

The picture record information table (content information table) 101b is a table including list information of picture record data stored in the picture record data memory device 101c. In the present embodiment, the picture record information table 101b is used to manage the picture record data stored in the picture record data memory device 101c based on commands from the picture record data control device 101a. Specifically, the picture record information table 101b is stored in a memory device (not shown) of the recording device 101.

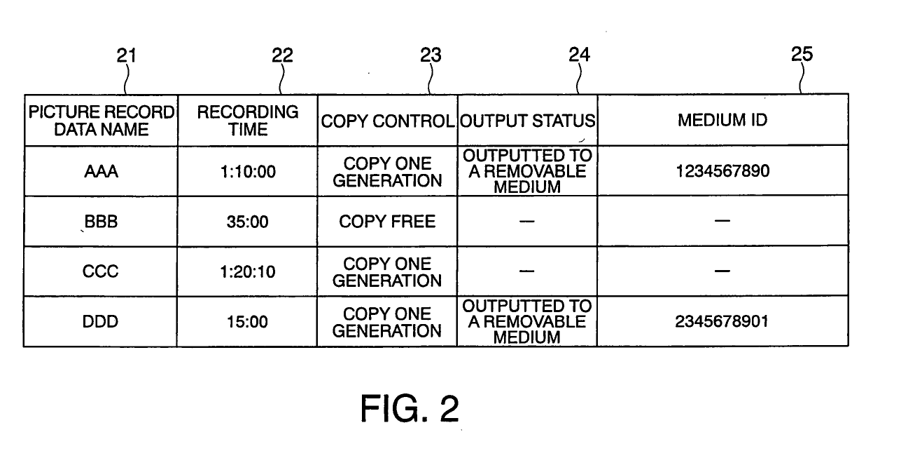

FIG. 2 is an explanatory diagram showing an example of the picture record information table 101b. As shown in FIG. 2, the picture record information table 101b includes a recording time 22, copy control information 23, an output status 24 of picture record data (hereinafter referred to as output status information), and a destination medium ID 25, all of which are made to correspond to each picture record data name 21 (“AAA” to “DDD”).

In FIG. 2, the picture record data name 21 is a data name of each of picture record data stored in the picture record data memory device 101c. The recording time 22 is a recording time of each of picture record data. The copy control information 23 is copy control information (signal) added to picture record data. In the present embodiment, the picture record information table 101b includes “copy one generation” or “copy free” as the copy control information 23.

The output status information 24 is information showing whether the picture record data have been outputted to an external removable medium. For example, when picture record data have been outputted to an external removable medium, the picture record information table 101b includes “outputted to a removable medium” as the output status information 24 corresponding to the outputted picture record data. The medium ID 25 is an ID of a removable medium to which picture record data have been outputted. For example, when picture record data have been outputted to an external removable medium, the picture record information table 101b includes an ID “1234567890” as the medium ID 25 corresponding to the outputted picture record data.

If a removable medium with an ID is used, the ID of the removable medium can be used as the destination medium ID 25. Further, if a removable medium without an ID is used, a unique ID may be generated for the medium and written into the removable medium when the recording device 101 writes picture record data into the removable medium.

In FIG. 2, among picture record data having copy control information 23 that includes “copy one generation,” both blank spaces in the output status information 24 and the medium ID 25 show that no picture record data is outputted to an external removable medium. For example, in the example shown in FIG. 2, the picture record data having picture record data names 21 of “AAA” and “DDD” show that the picture record data have been outputted to an external removable medium, and the picture record data having a picture record data name 21 of “CCC” show that the picture record data have not been outputted to an external removable medium.

Specifically, the picture record data memory device 101c is implemented by a hard disk device, a DVD-RAM, a memory, and the like. The picture record data memory device 101c has a function of storing digital content in digital television broadcasting and Internet broadcasting. The picture record data memory device 101c may store not only picture record data in digital television broadcasting and Internet broadcasting, but also content in cable television broadcasting and digital radio broadcasting. The picture record data memory device 101c may store a video stream purchased by a user. Further, the picture record data memory device 101c may store content of digitally encoded analog broadcasting and may store any other content as long as the content includes copy control information.

Specifically, the format conversion device 101d is implemented by a chip having a format conversion function, or by a CPU of the recording device 101, which operates according to software. The format conversion device 101d has a function of converting picture record data stored in the picture record data memory device 101c into a format that can be played back in the playback terminal 103 in accordance with a command from the picture record data control device 101a. Further, the format conversion device 101d also has a function of outputting the picture record data converted in format to the removable medium device 101e. For example, the format conversion device 101d converts data stored in the picture record data memory device 101c into a format for removable media. For example, the format conversion device 101d converts picture record data into SD-Video, DVD-Video, an MP3 format, or a format used in WMT.

Specifically, the removable medium device 101e is implemented by a variety of existing recording medium readers. For example, the removable medium device 101e is implemented by readers for recording media, such as SD memory card, Memory Stick, CompactFlash®, and SmartMedia, CD-RW drives, DVD-RAM drives, DVD-RW drives, DVD+RW drives, and the like.

The removable medium device 101e has a function of writing picture record data converted in format, which are inputted from the format conversion device 101d, into the removable medium 102. Further, the removable medium device 101e also has a function of reading picture record data stored in a newly inserted removable medium 102. Further, the removable medium device 101e may have a function of deleting picture record data stored in an inserted removable medium 102 when the picture record data control device 101a commands the removable medium device 101e to delete the picture record data.

Specifically, the removable medium 102 is implemented by a variety of existing recording media. For example, the removable medium 102 is implemented by SD memory card, Memory Stick, CompactFlash®, SmartMedia, CD-RW, DVD-RAM, DVD-RW, DVD+RW, and the like. In the present embodiment, the removable medium 102 is used for a user to carry picture record data stored in the recording device 101 and play back the picture record data with the playback terminal 103.

Likewise, the removable medium device 103a is implemented by a variety of existing recording medium readers. For example, the removable medium device 103a is implemented by readers for recording media such as SD memory card, Memory Stick, CompactFlash®, and SmartMedia, CD-RW drives, DVD-RAM drives, DVD-RW drives, DVD+RW drives, and the like.

The removable medium device 103a has a function of reading picture record data stored in the removable medium 102 and outputting the picture record data to the stream playback device 103b in accordance with a command from the stream control device 103c. Further, the removable medium device 103a may have a function of deleting picture record data stored in the removable medium 102.

The illustrated stream playback device 103b may be also implemented by a variety of existing digital content playback devices. For example, the stream playback device 103b is implemented by DVD-Video playback devices r SD-Video playback devices. The stream playback device 103b has a function of playing back picture record data delivered from the removable medium device 103a. The stream playback device 103b may have a speaker or a monitor for outputting decoded digital data.

Specifically, the stream control device 103c is implemented by a CPU of the playback terminal 103, which operates according to a program. The stream control device 103c has a function of commanding the stream playback device 103b to play back or output picture record data stored in the removable medium 102. Further, the stream control device 103c may have a function of commanding the removable medium device 103a to delete picture record data stored in the inserted removable medium 102.

In the present embodiment, a content memory means is implemented by the picture record data memory device 101c. A table memory means is implemented by the memory device of the recording device 101 for storing the picture record information table 101b. A content operation prohibition means and a picture record data prohibition means are implemented by the picture record data control device 101a. A picture record data writing means is implemented by the removable medium device 101e. A format conversion means is implemented by the format conversion device 101d. A picture record data reading means is implemented by the removable medium device 103a. A playback/deletion command means is implemented by the stream control device 103c. A payback means is implemented by the stream playback device 103b.

Next, operation will be described. In the present embodiment, when picture record data is outputted to an external medium, the picture record data control device 101a updates information in the picture record information table 101b that corresponds to the outputted picture record data into an outputted status. Further, when picture record data is deleted or has already been deleted from an external medium, the picture record data control device 101a updates information in the picture record information table 101b that corresponds to the deleted picture record data into a non-outputted status.

Further, when a user inputs a command to output, playback, edit, or move picture record data (hereinafter also referred to simply as operation), the picture record data control device 101a performs the following operation according to a software program. Specifically, the picture record data control device 101a determines whether the picture record data on which the operation is commanded has already been outputted to an external medium based on the picture record information table 101b. If it is determined that the picture record data has already been outputted, the picture record data control device 101a controls the recording device so as not to perform the operation commanded by the user. Further, if it is determined that the picture record data has not been outputted, the picture record data control device 101a controls the recording device so as to perform the operation commanded by the user.

In the present embodiment, the expression “to prohibit operation to picture record data” is used to comprehensively express those processes of the picture record data control device 101a, which are not performed and which include a process of updating the picture record information table 101b when picture record data is being outputted and a process of controlling the recording device so as not to perform the commanded operation when it is determined that the picture record data has been externally outputted. Further, the expression “to permit operation to picture record data” is used to comprehensively express those processes of the picture record data control device 101a, which include a process of updating the picture record information table 101b with regard to deleted picture record data and a process of controlling the recording device so as to perform the commanded operation when it is determined that the picture record data have not been externally outputted.

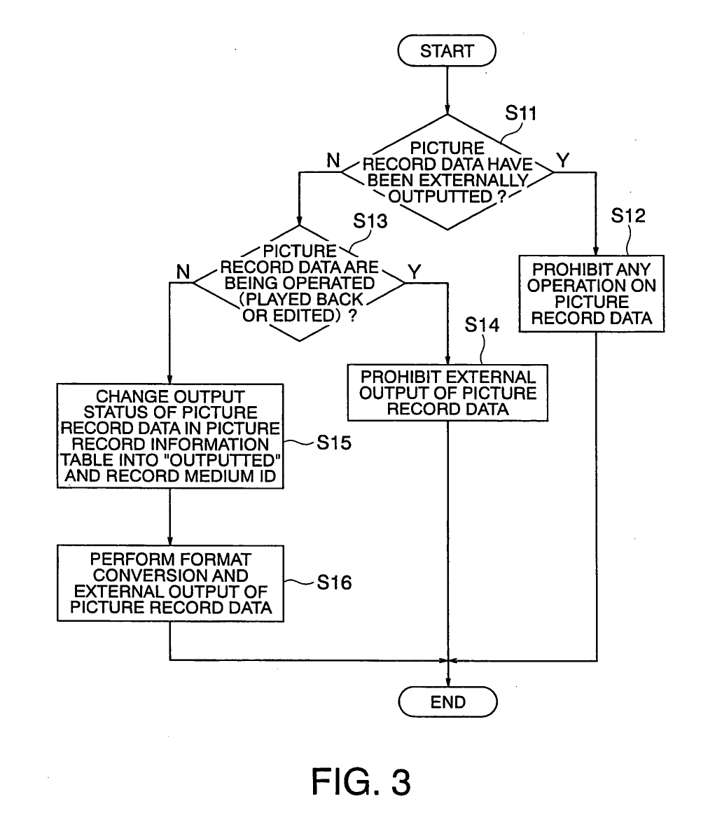

Operation of the content copy control apparatus will be described in some cases. First, operation to output picture record data to the removable medium 102 will be described below. FIG. 3 is a flow chart showing an example of an output control process, which is performed by the picture record data control device 101a when picture record data are to be outputted to the removable medium 102, and this output control process is performed according to a program. For example, when a user commands the picture record data control device 101a to output picture record data to which copy control information of “copy one generation” has been added, the picture record data control device 101a performs a control process to output the picture record data to the removable medium 102. On the other hand, when the picture record data control device 101a is commanded to output picture record data to which copy control information of “copy free” has been added, the picture record data control device 101a commands the format conversion device 101d to perform a format conversion on the picture record data specified by the user and output the picture record data without performing the output control process shown in FIG. 3.

The picture record data control device 011a determines whether the picture record data specified by the user is permitted to be outputted to the removable medium 102. If there are no problems, the picture record data control device 101a commands the format conversion device 101d to convert and output the picture record data. In the present embodiment, the picture record data control device 101a determines whether the specified picture record data currently has an externally outputted status based on the picture record information table 101b (Step S11). If it is determined that the specified picture record data has been externally outputted, then the picture record data control device 101a prohibits any operation on the specified picture record data (Step S12), and the process is terminated.

If it is determined that the specified picture record data has not been outputted, then the picture record data control device 011a determines whether the specified picture record data is being operated (Step S13). For example, the picture record data control device 101a determines whether the picture record data is being played back, edited, or moved. If it is determined that the picture record data is being operated, then the picture record data control device 101a does not output the specified picture record data externally (Step S14), a d the process is terminated.

If it is determined that the picture record data is not being operated, then the picture record data control device 101a changes the output status information 24 in the picture record information table 101b that corresponds to the specified picture record data, into “outputted to a removable medium.” Further, the picture record data control device 101a reads a unique ID of the destination removable medium 102 via the removable medium device 101e and records the unique ID as a medium ID 25 in the picture record information table 101b (Step S15). Then, the picture record data control device 101a commands the format conversion device 101d to perform a format conversion on the picture record data and outputs the converted picture record data to the removable medium device 101e (Step S16).

The format conversion device 101d performs a format conversion on the specified picture record data, of picture record data stored in the picture record data memory device 101c, and outputs the converted picture record data to the removable medium device 101e. Then, the removable medium device 101e writes the picture record data converted in format into the inserted removable medium 102.

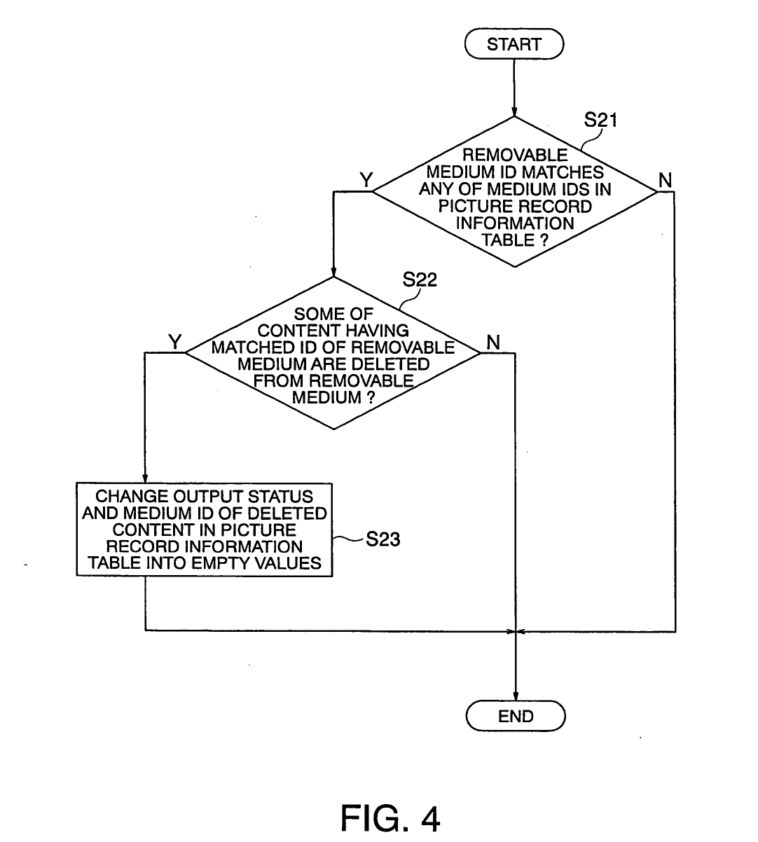

Next, operation in a case where a removable medium 102 is newly inserted into the removable medium device 101e will be described below. FIG. 4 is a flow chart showing an example of a control process, which is performed by the picture record data control device 101a when a removable medium 102 is newly inserted into the removable medium device 101e. For example, the picture record data control device 101a performs a control process when a removable medium 102 is newly inserted into the removable medium device 101e by a user.

The picture record data control device 101a extracts an ID of the newly inserted removable medium 102 via the removable medium device 101 and determines whether the ID of the removable medium 102 matches any of the medium IDs 25 in the picture record information table 101b (Step S21). Specifically, the picture record data control device 101a confirms an ID of the newly inserted removable medium 102 and determines whether the picture record information table 101b contains information of picture record data having been outputted to the removable medium 102. If it is determined that there is no information of the picture record data having the matched ID, then the picture record data control device 101a terminates the process.

If it is determined that there is information of the picture record data having the matched ID, then the picture record data control device 101a determines whether a whole of the picture record data having the matched ID exists in the removable medium 102 (Step S22). If it is determined that a whole of the picture record data exists in the removable medium 102, then the picture record data control device 101a terminates the process.

If it is determined that some of the picture record data do not exit (i.e., some of the picture record data have been deleted from the removable medium 102), the picture record data control device 101a updates the output status information 24 and the medium ID 25 in the picture record information table 101b that correspond to the deleted picture record data into empty values or states (Step S23). Specifically, the picture record data control device 101a updates the picture record information table 101b so as to permit operation to the original picture record data stored in the picture record data memory device 101c.

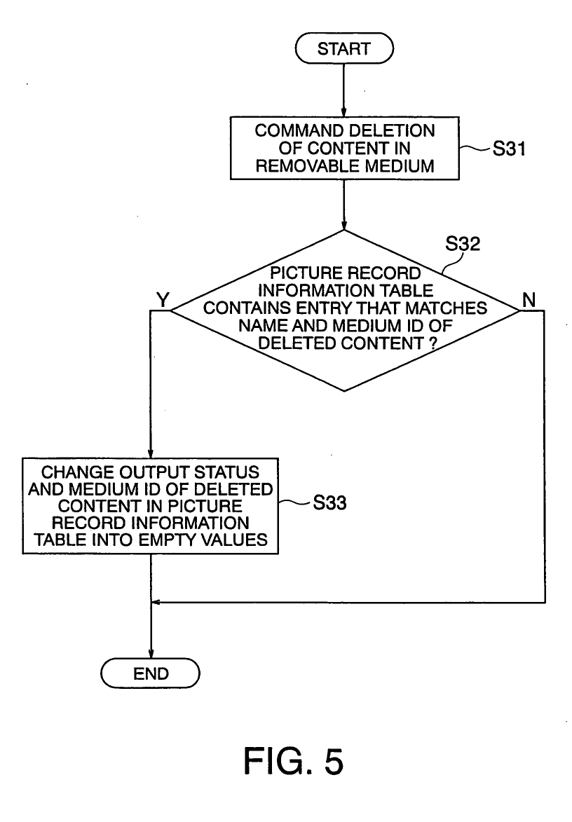

Next, operation to delete picture record data stored in the removable medium 102 inserted in the recording device 101 will be described below. FIG. 5 is a flow chart showing an example of a deletion control process, which is performed by the picture record data control device 101a when picture record data stored in the removable medium 102 are to be deleted. The picture record data control device 101a performs a deletion control process of picture record data when a user commands deletion of the picture record data.

The picture record data control device 101a commands the removable medium device 101e to delete the picture record data specified by the user (Step S31). Then, the removable medium device 101e deletes the specified picture record data from the removable medium 102. Further, the picture record data control device 101a determines whether information of the deleted picture record data is held by the picture record information table 101b. Specifically, the picture record data control device 101a determines whether the data name of the deleted picture record data matches the picture record data name 21 and whether the picture record information table 101b contains the information of picture record data having a medium ID 25 that matches the ID of the removable medium 102 (Step S32). If it is determined that the picture record information table 101b does not contain the information of the picture record data having the matched picture record data name 21 and medium ID 25, then the picture record data control device 101a terminates the process.

If it is determined that the picture record information table 101b contains the information of the picture record data having the matched picture record data name 21 and medium ID 25, then the picture record data control device 101a updates the output status information 24 and the medium ID 25 in the picture record information table 101b that correspond to the picture record data having the matched picture record data name 21 and medium ID 25 into empty values (Step S33). Specifically, the picture record data control device 101a updates the picture record information table 101b so as to permit operation to the original picture record data stored in the picture record data memory device 101c.

As described above, according to the present embodiment, when picture record data to which a copy control signal of “copy one generation” is added is outputted from the recording device 101 to the removable medium 102, the format conversion device 101d performs a format conversion on the picture record data stored in the picture record data memory device 101c. Then, the removable medium device 101e writes the picture record data converted in format into the removable medium 102. Further, the picture record data control device 101a records information in the picture record information table 101b that corresponds to the outputted picture record data and is written into a state of “being outputted”. As a result, all of operations are prohibited which include operations of playing back, moving, and copying the original picture record data in the recording device 101.

Accordingly, high-quality picture record data (digital content) to which a copy control signal of “copy one generation” is added can be carried with a portable terminal. The original picture record data in the recording device an be retained with the quality thereof kept unchanged. Specifically, according to the present embodiment, the original picture record data in the recording device 101 is outputted to the removable medium 102 but is stored in the recording device 101 with any operation prohibited. Then, the original picture record data is permitted to be operated after deletion of the picture record data in the removable medium 102. Thus, the picture record data can be converted into a format for portable devices and carried without degrading the quality of the picture record data.

Further, according to the present embodiment, the playback terminal 103 reads the picture record data from the removable medium 102 by the use of the removable medium device 103a and plays back the picture record data by the use of the stream playback device 103b. Furthermore, when the removable medium 102 is inserted into the removable medium device 101e of the recording device after the stream control device 103c has deleted the picture record data in the removable medium 102 according to a user's command input, the picture record data control device 101a automatically detects the deleted picture record data. Then, the picture record data control device 101a updates output information in the picture record information table 101b that corresponds to the deleted data so as to permit operation such as playing back or moving the picture record data.

Further, according to the present embodiment, when the picture record data in the removable medium 102 is deleted by using the removable medium device 101e of the recording device 101 according to a user's command input, the picture record data control device 101a automatically updates the output status information 24 (output information) in the picture record information table 101b. When the picture record data control device 101a automatically updates the corresponding output information, operation on the original picture record data is permitted again.

### Embodiment 2

Next, a second embodiment of the present invention will be described below with reference to the drawings. In the present embodiment, as with the first embodiment, picture record data is converted into a format for a playback terminal so that the picture record data can be carried with a removable medium. Original picture record data in a recording device can be retained while the quality thereof is maintained. Further, in addition to the effects obtained in the first embodiment, the present embodiment has an advantage in that content copy control can further be simplified by addition of a deletion means of picture record data.

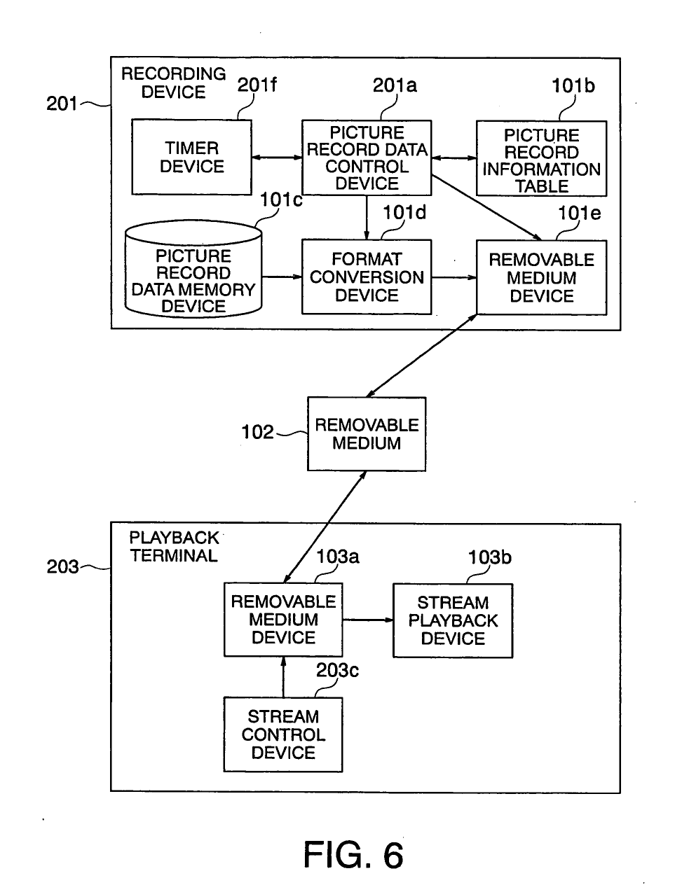

FIG. 6 is a block diagram showing another example of the arrangement of the content copy control apparatus. As shown in FIG. 6, the present embodiment differs from the first embodiment in that a recording device 201 includes a timer device 201f in addition to the arrangement of the recording device 101 shown in FIG. 1. Further, the present embodiment differs from the first embodiment in that a picture record data control device 201a and a stream control device 203c have functions different from those of the picture record data control device 101a and the stream control device 103c. In the present embodiment, components other than the picture record data control device 201a and the stream control device 203c have the same functions as those in the first embodiment.

The timer device 201f has a function of notifying the picture record data control device 201a that a predetermined period of time has elapsed when the predetermined period of time has elapsed since picture record data were outputted to the removable medium 102. In the present embodiment, the timer device 201f commands the picture record data control device 201a to restore output status information 24 and a medium ID 25 that correspond to the picture record data outputted to the removable medium 102 into empty value (i.e., non-outputted status) by notification that a predetermined period of time has elapsed.

The picture record data control device (deletion time set means) 201a has a function of adding information indicating when picture record data should automatically be deleted to the picture record data when the picture record data are outputted to the removable medium 102. Further, the picture record data control device 201a also has a function of setting the timer device 201f so that the timer device 201f operates after a predetermined period of time from an output time of the picture record data.

For example, the picture record data control device 201a write a file including an expected deletion time into the removable medium 102 in addition to the picture record data. Such time instant information serves to indicate a time instant of automatically deleting the picture record data. Further, for example, the picture record data control device 201a adds time instant information to a writable area in a user area included in the picture record data after the format conversion. Thus, time instant information can be added to indicate time at which the picture record data should automatically be deleted.

The stream control device 203c has a function of detecting added time instant information in a case where time instant information at which the picture record data should be automatically deleted is added to the picture record data stored in the removable medium 102 inserted in the removable medium device 103a. Further, the stream control device 203c also has a function of deleting picture record data from the removable medium 102 when the detected time information is older than the current time.

Next, operation will be described below. For example, when user commands the picture record data control device 201a to output picture record data to which copy control information of “copy one generation” has been added, the picture record data control device 201a starts a control process to output the picture record data to the removable medium 102. The picture record data control device 201a sets the timer device 201f so that the timer device 201f starts to operate after a predetermined period of time when the picture record data stored in the picture record data memory device 101c are outputted to the removable medium 102. Further, the picture record data control device 201a writes the start time set for the timer device 201f as an automatic deletion time of the picture record data, into the removable medium 102.

The timer device 201f starts to operate after the predetermined period of time has elapsed, and commands the picture record data control device 201a to update the output status information 24 and the medium ID 25 of the picture record data outputted to the removable medium 102 (or to change them into a non-outpufted status). Then, the picture record data control device 201a updates both the output status information 24 and the medium ID 25 in the picture record information table 101b into empty states, that correspond to the picture record data on which update is commanded. Namely, the picture record data control device 201a restores the picture record data on which update is commanded into a non-outputted status.

In a case where an automatic deletion time is set for the picture record data stored in the removable medium 102 inserted in the removable medium device 103a, the stream control device 203c deletes the picture record data to be deleted from the removable medium 102 at the automatic deletion time. Further, if the stream control device 203c determines that the automatic deletion time has already passed, the stream control device 203c deletes the picture record data to be deleted from the removable medium 102.

As described above, according to the present embodiment, the timer device 201f is provided for indicating the automatic deletion time of the picture record data to the recording device, and an additional operation means is provided for deleting the picture record data in the removable medium 102. According to the present embodiment, after a predetermined period of time has elapsed from the time at which the picture record data was written into the removable medium 102, the stream control device 203c in the playback terminal 203 automatically deletes the picture record data in the removable medium 102 without a user's command input to delete the picture record data from the removable medium 102.

Further, at the same time when the picture record data are deleted by the stream control device 203c, the timer device 201f of the recording device 201 commands the picture record data control device 201a to update the output status information 24 in the picture record information table 101b. Then, the picture record data control device 201a updates the output status information 24 so as to permit operation of the original picture record data. Accordingly, deletion of the picture record data from the removable medium 102 after the output of the picture record data can be automated, so that an input operation of a user n be simplified.

### Embodiment 3

Next, a third embodiment of the present invention will be described below with reference to the drawings. In the present embodiment, as with the first embodiment, picture record data is converted into a format for a playback terminal so that the picture record data can be carried with a removable medium. Original picture record data in a recording device can be retained while the quality thereof is maintained. Further, in addition to the effects obtained in the first embodiment, the present embodiment has an advantage in that a content copy control can further be simplified by addition of a notification means of deletion operation of picture record data.

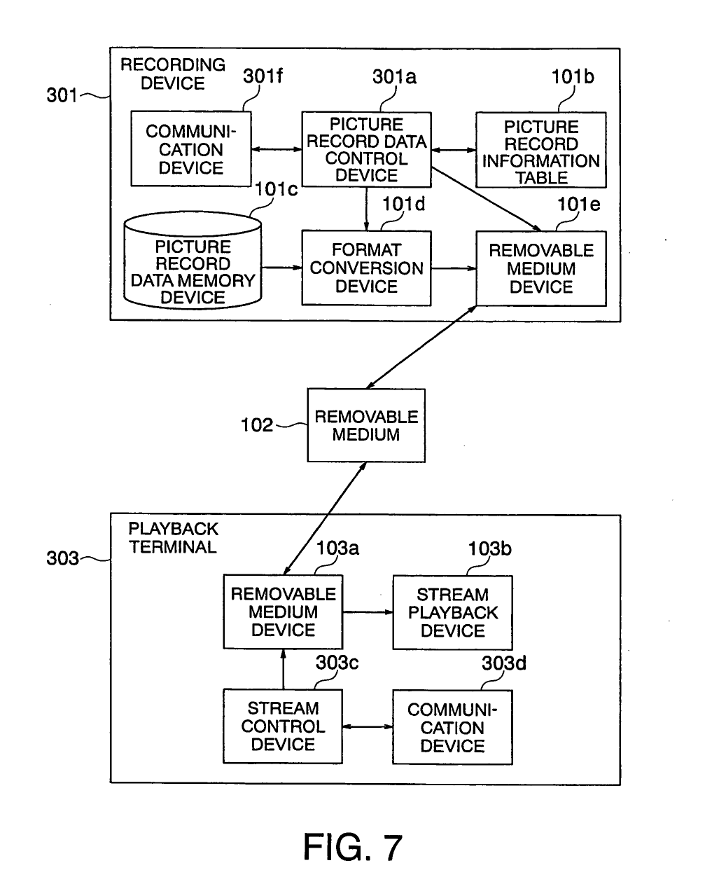

FIG. 7 is a block diagram showing still another example of the arrangement of the content copy control apparatus. As shown in FIG. 7, the present embodiment differs from the first embodiment in that a communication device 301f and a communication device 303d are included in addition to the arrangement of the recording device 101 shown in FIG. 1. Further, the present embodiment differs from the first embodiment in that a picture record data control device 301a and a stream control device 303c have functions different from those of the picture record data control device 101a and the stream control device 103c. In the present embodiment, components other than the picture record data control device 301a and the stream control device 303c have the same functions as those in the first embodiment.

For example, the communication device 301f is implemented by a cellular phone or a PHS connected to a recording device 301. Further, for example, the communication device 301f is implemented by various communication means such as an interface part having a fixed telephone network connection function, an IP telephone function, a wireless LAN connection function, or an infrared communication function.

The communication device 301f has a function of extracting (receiving) information indicative of the fact that picture record data has been deleted from the removable medium 102 inserted in a playback terminal 303 (hereinafter referred to as deletion notification information) from the communication device 303d. Further, the communication device 301f also has a function of transmitting (outputting) the received deletion notification information to the picture record data control device 301a. Furthermore, the communication device 301f also has a function of sending a deletion command of picture record data, which is inputted from the picture record data control device 301a, to the communication device 303d of the playback terminal 303 when the original picture record data, which has been externally outputted, are to be operated in the recording device 301.

The picture record data control device 301a has a function of updating the output status information 24 in the picture record information table 101b that corresponds to the deleted picture record data (or restoring it into a non-outputted status) based on the deletion notification information received from the communication device 301f. Further, when a user commands, by the use of the recording device 301, operation of the picture record data having an externally outputted status, the picture record data control device 301a also has a function of outputting information for commanding the playback terminal 303 in which a destination removable medium 102 has been inserted. Such information is indicative of deleting the picture record data and may be hereinafter referred to as deletion command information. At any rate, the deletion command information is transmitted from the picture record data control device 301a to the communication device 301f.

The stream control device 303c has a function of outputting a ID of the removable medium 102 and a content name of the deleted data to the communication device 303d when the picture record data are deleted from the removable medium 102 inserted in the playback terminal 303. Further, the stream control device 303c also has a function of deleting the picture record data to be deleted from the removable medium 102 when the deletion command information is received from the communication device 303d.

For example, the communication device 303d is implemented by a cellular phone or a PHS connected to a playback terminal 303 as a portable player. Further, for example, the communication device 303d is implemented by various communication means such as an interface part having a fixed telephone network connection function, an IP telephone function, a wireless LAN connection function, or an infrared communication function.

The communication device (deletion notification sending means 303d has a function of notifying (sending) the deletion notification information to the communication device 301f when the stream control device 303c deletes the picture record data from the removable medium 102 inserted in the removable medium device 103a. In this case, the communication device 303d sends the deletion notification information including an ID of the removable medium 102 and a content name of the deleted data. Further, the communication device 303d also has a function of notifying (outputting) the received deletion command information to the stream control device 303c when the deletion command information is received from the communication device 301f.

Next, operation Will be described below. First, description will be made about operation performed in a case where picture record data is deleted from the removable medium 102 in the playback terminal 303. For example, when a user commands deletion of picture record data, the stream control device 303c deletes the picture record data from the removable medium 1020. When the picture record data is deleted from the removable medium 102 inserted in the playback terminal 303, the stream control device 303c outputs an ID of the removable medium 102 and a name (content name) of the deleted picture record data to the communication device 303d. Then, the communication device 303d sends deletion notification information including the ID of the removable medium 102 and the name of the deleted picture record data to the communication device 301f of the recording device 301.

The communication device 301f outputs the received deletion notification information to the picture record data control device 301a. The picture record data control device 301a performs retrieval of the picture record information table 101b based on the deletion notification information and updates the output status information 24 and the medium ID 25 that correspond to the picture record data notified of deletion into empty values. Specifically, the picture record data control device 301a changes the output status information 24 and the medium ID 25 into a non-outputted status so as to restore a state in which operation of the original picture record data is permitted in the recording device 301.

Next, description will be made about operation performed in a case where deletion of picture record data is commanded in the recording device 301. For example, when a user inputs an operation command of picture record data outputted to the removable medium 102 while original data thereof is retained in the recording device 301, the picture record data control device 301a starts a deletion command process of the outputted picture record data. The picture record data control device 301a commands the communication device 301f to send deletion command information to the communication device 303d the playback terminal 303 in which the removable medium 102 is inserted. Then, the communication device 301f sends the deletion command information to the communication device 303d.

The communication device 303d outputs the received deletion command information to the stream control device 303c. The stream control device 303c commands the removable medium device 103a to delete the picture record data on which deletion is commanded based on the deletion command information. Further, the picture record data control device 301a of the recording device 301 updates the output status information 24 and the medium ID 25 in the picture record information table 101b that correspond to the picture record data requested to be deleted into empty states. Specifically, the picture record data control device 301a changes the output status information 24 and the medium ID 25 into a non-outputted status so as to restore a state in which operation of the original picture record data is permitted in the recording device 301.

As described above, according to the present embodiment, the communication device 303d is provided for notifying the recording device 301 of deletion operation of picture record data, and a notification means of deletion operation of picture record data in the playback terminal 303 is provided. According to the present embodiment, even if the removable medium 102 is not inserted in the recording device 301, it is possible to grasp a deletion state in the removable medium 102 by communication with the playback terminal 303 and to control permission of operation of the original picture record data.

Further, according to the present embodiment, when operation of the original picture record data becomes necessary in the recording device 301, the picture record data in the removable medium 102 inserted in the portable terminal (playback terminal 303) can be deleted with use of the communication d vices 301f and 303d. Thus, operation of the original picture record data is permitted in the recording device 301 by remote control using the communication devices 301f and 303d. Accordingly, it is possible to notify a deletion operation of picture record data written into the removable medium 102 and a playback request of original picture record data with use of the communication means, so that an input operation of a user can be simplified.

### Embodiment 4

Next, a fourth embodiment of the present invention will be described below with reference to the drawings. In the present embodiment, a recording device 401 and a playback terminal 403 has input/output terminals for inputting and outputting digital streams instead of the removable medium devices 101e and 103a, so that it is possible to obtain similar effects to the effects in the first embodiment.

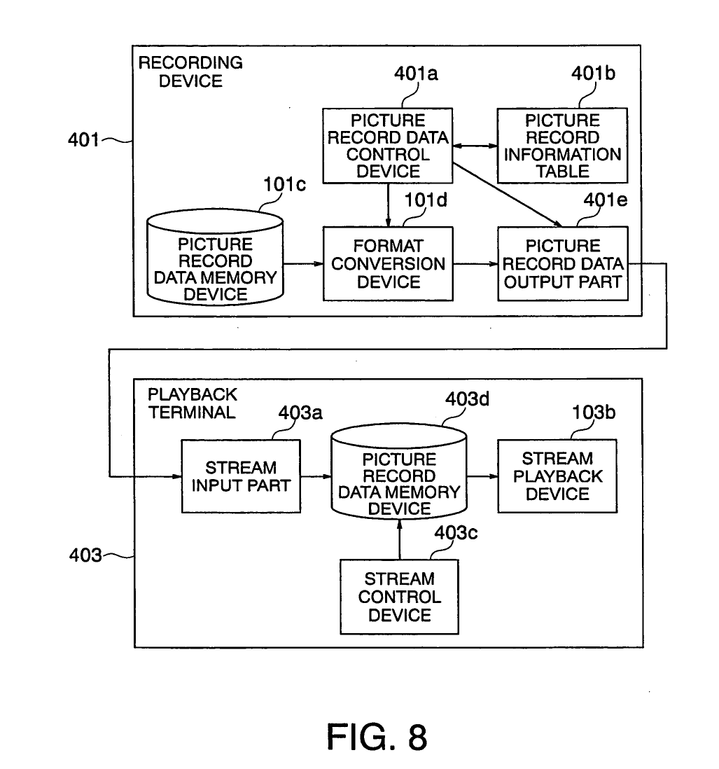

FIG. 8 is a block diagram showing still another example of the arrangement of the content copy control apparatus. As shown in FIG. 8, the present embodiment differs from the first embodiment in that the recording device 401 includes a picture record data output part 401e instead of the removable medium device 101e shown in FIG. 1. Further, the present embodiment differs from the first embodiment in that the playback terminal 403 includes a stream input part 403a instead of the removable medium device 103a shown in FIG. 1. Furthermore, the present embodiment differs from the first embodiment in that the playback terminal 403 includes a stream memory device 403d in addition to the arrangement of the playback terminal 103 shown in FIG. 1.

Further, the present embodiment differs from the first embodiment in that a picture record data control device 401a and a stream control device 403c have functions different from those of the picture record data control device 101a and the stream control device 103c. Furthermore, the present embodiment differs from the first embodiment in that a picture record information table 401b has contents different from those of the picture record information table 101b. In the present embodiment, components other than the picture record data control device 401a and the stream control device 403c have the same functions as those in the first embodiment.

The picture record data control device 401a has a function of commanding the format conversion device 101d to output picture record data stored in the picture record data memory device 101c to the playback terminal 403 and recording the outputted picture record data in the picture record information table 401b. Further, the picture record data control device 401 also has a function of confirming picture record data stored in the stream memory device 403d of the playback terminal 403 connected to the recording device 401 and reflecting information of picture record data deleted from the stream memory device 403d upon the picture record information table 401b. Furthermore, the picture record data control device 401a may have a function of commanding deletion of picture record data from the stream memory device 403d of the playback terminal 403 connected to the recording device 401.

The picture record information table 401b is a table including list information of picture record data stored in the picture record data memory device 101c. In the present embodiment, the picture record information table 411b is used to manage the picture record data stored in the picture record data memory device 101c based on commands from the picture record data control device 401a.

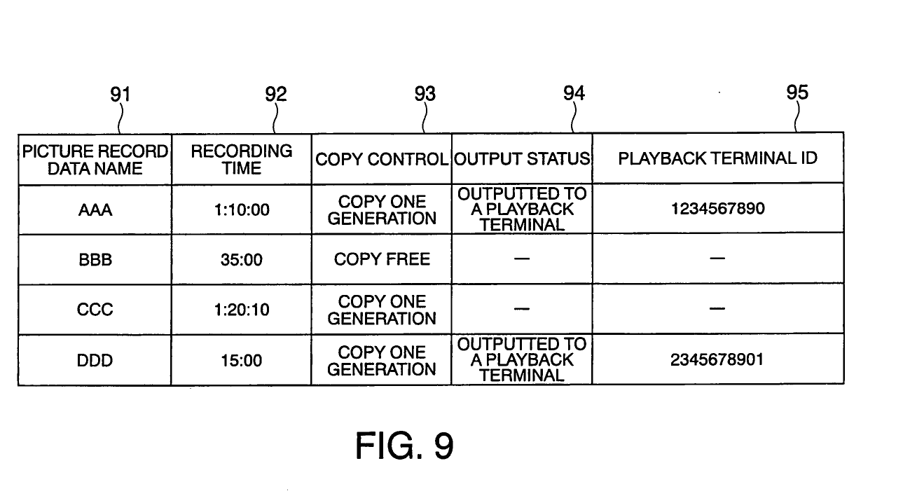

FIG. 9 is an explanatory diagram showing an example of the picture record information table 401b. As shown in FIG. 9, the picture record information table 401b includes a recording time 92, copy control information 93, an output status (output status information) 94 of picture record data, and a destination playback terminal ID 95, all of which are made to correspond to each picture record data name 91 (“AAA” to “DDD”).

In FIG. 9, the picture record data name 91 is a data name of each of picture record data stored in the picture record data memory device 101c. The recording time 92 is a recording time of each of picture record data. The copy control information 93 is copy control information (signal) added to picture Record data.

The output status information 94 is information showing w ether picture record data has been outputted to an external playback terminal. For example, when picture record data has been outputted into an external playback terminal, the picture record information table 401b includes “outputted to a playback termninal” as the output status information 94 corresponding to the outputted picture record data. The playback terminal ID 95 is an ID of a playback terminal to which picture record data has been outputted. For example, when picture record data has been outputted to an external playback terminal, the picture record information table 401b includes an ID “1234567890” as the playback terminal ID 95 corresponding to the outputted picture record data.

A serial number of the playback terminal 403, an ID of a chip used in the playback terminal 403, or a MAC address of a network device of the playback terminal 403 may be used as the destination playback terminal ID 95. Further, if a playback terminal 403 without an ID is used, a unique ID may be generated for the playback terminal 403 and written into a storage device (not shown) of the playback terminal 403 or the like when picture record data are outputted to the playback terminal 403.

In FIG. 9, of picture record data having copy control information 93 of “copy one generation,” information of picture record data having blank spaces of the output status information 94 and the playback terminal ID 95 shows that the picture record data have not been outputted to an external playback terminal. For example, in the example shown in FIG. 9, the picture record data having picture record data names 91 of “AAA” and “DDD” show that the picture record data has been outputted to an external playback terminal, and the picture record data having a picture record data name 91 of “CCC” shows that the picture record data has not been outputted to an external playback terminal.

For example, the picture record data output part 401e is implemented by an input/output interface part of the recording device 401 in accordance with an IEEE 1394 standard or a USB standard, a network interface part in accordance with an Ethernet® standard, or the like. Further, for example, the picture record data output part 401c is implemented by other various devices capable of transferring picture record data, such as a network interface part connectable to a wireless LAN.

The picture record data output part 401e has a function of outputting picture record data converted in format that is inputted from the format conversion device 101d to the stream input part 403a of the playback terminal 403. Further, the picture record data output part 401e also has a function of reading picture record data stored in a stream memory device 403d of a newly connected playback terminal 403. Furthermore, the picture record data output part 401e may have a function of commanding the playback terminal 403 connected to the recording device 401 to delete data when the picture record data control device 401a commands deletion of picture record data in the playback terminal 403.

For example, the stream input part 403a is implemented by an input/output interface part of the playback terminal 403 in accordance with an IEEE 1394 standard or a USB standard, a network interface part in accordance with an Ethernet® standard, or the like. Further, for example, the stream input part 403a is implemented by other various devices capable of transferring picture record data, such as a network interface part connectable to a wireless LAN.

The stream input part 403a has a function of storing picture record data inputted from the picture record data output part 401e into the stream memory device 403d. Further, the stream input part 403a may have a function of commanding the stream memory device 403d to delete picture record data when deletion command information to command deletion of picture record data in the stream memory device 403d is inputted from the picture record data output part 401e.

The stream control device 403c has a function of commanding the stream playback device 103b to play back or output picture record data stared in the stream memory device 403d. Further, the stream control device 403p also has a function of deleting picture record data stored in the stream memory device 403d.

Specifically, the stream memory device 403d is implemented by a hard disk device, a DVD-RAM, a memory, or the like. The stream memory device 403d has a function of storing picture record data converted in format t at are inputted from the recording device 401. In the present embodiment, since the playback terminal 403 has the stream memory device 403d, picture record data can be played back with the playback terminal 403 even if the picture record data output part 401e and the stream input part 403a are disconnected from each other.

In the present embodiment, a picture record data output means is implemented by the picture record data output part 401e. A picture record data input means is implemented by the stream input part 403a. A picture record data memory means is implemented by the stream memory device 403d.

Next, operation will be described below. First, description will be made about operation carried out in a case where picture record data in the recording device 401 is outputted to the playback terminal 403. For example, when a user commands output of picture record data to which copy control information of “copy one generation” is added, the picture record data control device 401a performs a control process to output the picture record data to the playback terminal 403. The picture record data control device 401a determines whether the picture record data is permitted to be outputted, based on the output status information 94 in the picture record information table 401b. If there are no problems, the picture record data control device 401a commands the picture record data output part 401e to output the picture record data that has been converted in format.

In the present embodiment, the picture record data control device 401a determines whether the picture record data specified by the user is permitted to be outputted to the playback terminal 403 based on the output status information 94 in the picture record information table 401b. The method of determining whether or not the picture record data can be outputted from the picture record data control device 401a is the same as the method of determining whether or not the picture record data can be outputted from the picture record data control device 101a of the first embodiment. Specifically, the picture record data control device 401a determines that the picture record data is permitted to be outputted if the output status information 94 is not “outputted to a playback terminal.” Further, the picture record data control device 401a determines that the picture record data cannot be outputted if the output status information 94 is “outputted to a playback terminal,” and the process is terminated.

If the picture record data control device 401a determines that the picture record data is permitted to be outputted, then the picture record data control device 401a commands the picture record data output part 401e to output the picture record data that has been converted in format by the format conversion device 101d. Then, the picture record data output part 401e outputs the picture record data converted in format to the stream input part 403a of the playback terminal 403. Thereafter, the stream input part 403a stores the picture record data inputted from the picture record data output part 401e into the stream memory device 403d.

Next, description will be made about operation carried out in a case where a playback terminal 403 is newly connected to the recording device 401. For example, when a user newly connects a playback terminal 403 to the recording device 401, the picture record data control device 401a performs a control process.

The picture record data control device 401a confirms an ID of the newly connected playback terminal 403 and determines on the basis of the picture record information table 401b whether or not there is picture record data that has been outputted. Specifically, the picture record data control device 401a extracts an ID from the playback terminal 403 and determines whether there is picture record data having an ID that matches the extracted playback terminal ID 95.

The picture record data control device 401a determines whether all of the picture record data having been outputted are stored in the stream memory device 403d of the playback terminal 403. If some of the outputted picture record data have been deleted from the playback terminal 403, then the picture record data control device 401a updates the output status information 94 and the playback terminal ID 95 in the picture record information table 401b that correspond to the deleted picture record data into empty states. Specifically, the picture record data control device 401a updates the picture record information table 401b so as to permit other operations such as a playback of the original picture record data stored in the picture record data memory device 101c.

Next, description will be made about operation of deleting picture record data stored in the stream memory device 403d of the playback terminal 403 connected to the recording device 401. For example, when a user commands deletion of picture record data, the picture record data control device 401a performs a deletion control process of the picture record data.

The picture record data control device 401a commands the picture record data output part 401e to delete the picture record data specified by the user. Then, the picture record data output part 401e notifies the stream input part 403a of the deletion command of the picture record data. Specifically, the picture record data output part 401e outputs the deletion command information to the stream input part 403a in accordance with the command from the picture record data control device 401a. Responsive to the deletion command information, the stream input part 403a deletes the picture record data on which deletion is commanded from the stream memory device 403d.

The picture record data control device 401a determines whether the picture record information table 401b holds information of the picture record data deleted from the playback terminal 403. Specifically, the picture record data control device 401a determines whether the output status information 941 in the picture record information table 401b that corresponds to the deleted picture record data is representative of “being outputted to a playback terminal.” If the picture record data control device 401a determines that the information of the picture record data deleted from the playback terminal 403 is held by the picture record information table 401b, the picture record data control device 401a updates the output status information 94 and the playback terminal ID 95 in the picture record information table 401b that correspond to the deleted picture record data into empty states. Specifically, the picture record data control device 401a updates the picture record information table 401b so as to permit other operations such as a playback of the original picture record data stored in the picture record data memory device 101c.

As described above, according to the present embodiment, the content copy control apparatus includes the recording device 401 having the picture record data output part 401e in accordance with an IEEE 1394 standard or the like, instead of the removable medium device 101e. Further, the content copy control apparatus includes the playback terminal 403 having the stream input part 403a in accordance with an IEEE 1394 standard or the like and the stream memory device 403d for storing picture record data received from the recording device 401.

Accordingly, by using the recording device 401 and the playback terminal 403 having a stream input/output terminal and a hard disk device for storing stream data and the playback terminal 403, original picture record data can be retained in the recording device 401 with the quality kept unchanged and the same effects as in the first embodiment can be obtained without use of a removable medium.

### INDUSTRIAL APPLICABILITY

A content copy control apparatus according to the present invention is applicable to purposes of copying digital content such as digital television broadcasting to which a copy control signal is added to a removable medium. Particularly, content to which a copy control signal of “copy one generation” is added is converted in format so that the content can be carried with a portable terminal. Original content in a recording device can be retained while the quality thereof is maintained.

1. A content copy control apparatus for copying content to a portable removable medium, characterized by comprising:
content memory means for storing content;
table memory means for recording a content information table in which the content stored by the content memory means is associated with output status information indicating whether the content has been outputted to a removable medium; and
content operation prohibition means for prohibiting operation to content outputted to the removable medium, among the content stored by the content memory means, based on the content information table recorded by the table memory means.

2. A content copy control apparatus for copying picture record data as content to a portable removable medium with a recording device for storing the picture record data and a playback terminal for playing back the picture record data, characterized in that:
the recording device includes:
table memory means for recording a picture record information table in which the picture record data stored in the recording device is associated with output status information indicating whether the picture record data has been outputted to a removable medium;
picture record data prohibition means for prohibiting operation to picture record data outputted to the removable medium, among the picture record data stored in the recording device, based on the picture record information table stored by the table memory means;
format conversion means for converting the picture record data in format; and
picture record data writing means for writing the picture record data converted in format by the format conversion means into the removable medium, and
the playback terminal includes:
picture record data reading means for reading the picture record data from the removable medium;
playback/deletion command means for commanding playback or deletion of the picture record data stored in the removable medium; and
playback means for playing back or outputting the picture record data stored in the removable medium in accordance with a command from the playback/deletion command means.

3. The content copy control apparatus as recited in claim 2, comprising deletion time set means for setting time at which picture record data written into the removable medium are to be deleted,
wherein the playback/deletion command means commands deletion of picture record data from the removable medium after a predetermined period of time has elapsed since the picture record data were written into the removable medium, in accordance with the set time set by the deletion time set means,
wherein the picture record data prohibition means updates the output status information in the picture record information table that corresponds to the deleted picture record data into information indicating that the picture record data has not been outputted, at the same time when the playback/deletion command means deletes the picture record data, in accordance with the set time set by the deletion time set means.

4. The content copy control apparatus as recited in claim 2, wherein the playback terminal includes deletion notification sending means for sending deletion notification information indicating that the picture record data has been deleted from the removable medium to the recording device,
wherein the picture record data prohibition means updates the output status information in the picture record information table that corresponds to the deleted picture record data into information indicating that the picture record data has not been outputted, based on the deletion notification information received from the playback terminal.

5. The content copy control apparatus as recited in claim 2, wherein the recording device includes picture record data output means for outputting the picture record data converted in format by the format conversion means to the playback terminal,
wherein the playback terminal includes:
picture record data input means for inputting the picture record data outputted from the picture record data output means, and
picture record data memory means for storing the picture record data inputted by the picture record data input means,
wherein the table memory means records a picture record information table in which the picture record data stored in the recording device is associated with output status information indicating whether the picture record data has been outputted to the playback terminal,
wherein the picture record data prohibition means prohibits operation to picture record data outputted to the playback terminal, among the picture record data stored in the recording device, based on the picture record information table,
wherein the playback/deletion command means commands playback or deletion of the picture record data stored in the picture record data memory means,
wherein the playback means plays back or outputs the picture record data stored in the picture record data memory means in accordance with a command from the playback/deletion command means.

6. A content copy control method of copying content to a portable removable medium, characterized by comprising:
a step of storing content; and
a step of prohibiting operation to content outputted to a removable medium, of the stored content, based on a content information table in which the stored content is associated with output status information indicating whether the content has been outputted to the removable medium.

7. A content copy control method characterized by comprising:
a step in which a recording device for storing picture record data as content prohibits operation to picture record data outputted to a portable removable medium, among the picture record data stored in the recording device, based on a picture record information table in which the stored picture record data are associated with output status information indicating whether the picture record data has been outputted to the removable medium;
a step in which the recording device converts the picture record data in format;
a step in which the recording device writes the picture record data converted in format into the removable medium;
a step in which a playback terminal for playing back picture record data reads the picture record data from the removable medium;
a step in which the playback terminal commands playback or deletion of the picture record data stored in the removable medium; and
a step in which the playback terminal plays back or outputs the picture record data stored in the removable medium.

8. The content copy control method as recited in claim 7, comprising:
a step of setting time at which picture record data written into the removable medium are to be deleted;
a step in which the playback terminal deletes the picture record data from the removable medium after a predetermined period of time has elapsed since the picture record data were written into removable medium, in accordance with the set time; and
a step of updating the output status information in the picture record information table that corresponds to the deleted picture record data into information indicating that the picture record data has not been outputted, at the same time when the picture record data are deleted, in accordance with the set time.

9. The content copy control method as recited in claim 7, comprising:
a step in which the playback terminal sends deletion notification information indicating that the picture record data has been deleted from the removable medium to the recording device; and
a step in which the recording device updates the output status information in the picture record information table that corresponds to the deleted picture record data into information indicating that the picture record data has not been outputted, based on the deletion notification information received from the playback terminal.

10. The content copy control method as recited in claim 7, comprising:
a step in which the recording device prohibits operation to picture record data outputted to the playback terminal, among the picture record data stored in the recording device, based on a picture record information table in which the picture record data stored in the recording device is associates with output status information indicating whether the picture record data has been outputted to the playback terminal;
a step in which the recording device outputs the picture record data converted in format to the playback terminal;
a step in which the playback terminal inputs the picture record data outputted from the recording device;
a step in which the playback terminal stores the inputted picture record data;
a step in which the playback terminal commands playback or deletion of the stored picture record data; and
a step in which the playback terminal plays back or outputs the stored picture record data.

11. A content copy control apparatus for copying picture record data as content, the content copy control apparatus comprising a recording device for storing the picture record data and a playback terminal for playing back the picture record data, characterized in that:
the recording device includes:
table memory means for recording a picture record information table in which the picture record data stored in the recording device is associated with output status information indicating whether the picture record data has been outputted;
picture record data prohibition means for prohibiting operation to picture record data outputted to the playback terminal, among the picture record data stored in the recording device, based on the picture record information, table stored by the table memory means; and
the playback terminal includes:
picture record data reading means for reading the picture record data from the recording device;
playback/deletion command means for commanding playback or deletion of the picture record data stored in the playback terminal; and
deleting means for deleting the picture record data from the playback terminal in response to a command representative of the deletion from the playback/deletion command means.
